(19) United States
(12) Patent Application Publication
(10) Pub. No.: US 2010/0281351 A1
(43) Pub. Date: Nov. 4, 2010

(54) WEB PRINT CONTENT CONTROL USING HTML

(76) Inventor: Soiba Mohammed, Sunnyvale, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/432,671

(22) Filed: Apr. 29, 2009

(51) Int. Cl. G06F 17/00; G06F 3/00

(52) U.S. Cl. 715/205; 715/234; 715/760

(57) ABSTRACT

A web page is enhanced with “print tags.” These print tags indicate which portions of a web page's data belong to which content items. The print tags identify and distinguish between the content items. The web browser uses the tags to differentiate “real” content from advertisements on the web page, so that unimportant content is not printed. Additionally, if a content item is distributed over several pages, then the print tags convey information about which hyperlinks the web browser should automatically follow in order to obtain and print the entire content item. The print tags are embedded into the web document itself. In approaches discussed herein, the user does not need to cause his web browser to request any additional “printer-friendly” web page, because the browser automatically generates print data using the HTML print tags that are already contained in the web page that the user asked to be printed.

### FIELD OF THE INVENTION

The invention relates to printing, and more specifically, to systems and techniques for allowing a web page author to control, using HTML tags embedded in the web page, which material in a web page will be printed.

### BACKGROUND

Content delivered on the Internet is designed for viewing in an Internet browser (such as Mozilla Firefox, for example) window on a computer system. Such content, when delivered on the Internet, is often contained on a web page. The dimensions of the web page sometimes will be so great that the entire contents of the web page cannot all be displayed in the browser window at once. Under such circumstances, the content is often formatted to be scrolled up and down and left to right, so that the browser's user can manually focus the browser's window on certain portions of the web page's content. Images and advertisements are sometimes embedded within the web page. Content displayed on a web page may also include a cohesive set of related text such as a newspaper article, magazine article, or story.

Sometimes, a single web page will contain multiple separate content items. Each such content item may be associated with certain text and certain images. Sometimes, a web page will contain the initial portions of several different content items, and will contain, for each of those content items, hypertext links to other web pages that also contain further portions of those content items. For example, similar to the way that a front page of a newspaper often contains multiple different stories by multiple different authors, and relating to multiple different subjects, a web page also might contain multiple different content items, each of which is followed by a separate hyperlink to a next portion of that content item. A particular content item that begins on an initial web page may actually span multiple separate web pages. To read the whole content item, the user might need to click on multiple different hyperlinks on multiple different web pages, each of which contains a separate portion of the content item in which the user is interested.

FIG. 1 shows an example of a portion of a web page as that web page might be partially displayed in an Internet browser's window. As is apparent, only a portion of the web page is visible; a further portion of the web page continues beyond the lower boundary of the browser window. A user desiring to see that portion of the web page typically is required to manipulate a thumb tab in the web browser's vertical scroll bar in order to scroll the focus of the browser's window further down the web page.

The web page shown in FIG. 1 also contains portions (and only portions, for none are completely displayed) of several different, separate stories. Each such story is a separate content item, pertaining to a different subject. Story 102 pertains to the U.S. economy. Story 104 pertains to a conflict in Afghanistan. Story 106 pertains to events in Tibet. Story 108 pertains to a professional basketball tournament. Notably, story 108 is associated with a displayed image that relates to the basketball tournament which is the subject of story 108. Also included on the web page is an advertisement 110, which in this case is in the form of an image. Each of stories 102-108 contains at least one hyperlink (typically, a hyperlink whose text constitutes the title of that story) which, when clicked on or otherwise selected by the user of the Internet browser, causes the Internet browser to navigate to a different web page that contains further contents related to that particular story (and possibly no other story but that one). The web page to which the Internet browser navigates in response to the user's selected typically will be associated with a different Uniform Resource Locator (URL) than the URL that is associated with the initial web page that is shown in FIG. 1.

Typically, when a viewer of the web page shown in the browser windows instructs the browser to print the web page (e.g., by clicking on a “print” menu command provided by the browser), if the dimensions of the web page are so large that the whole web page cannot fit on one sheet of paper, the print functionality will divide the page's contents into multiple areas and print each of those areas on a separate sheet of paper. Typically, the way in which the print functionality divides the page's contents is not intelligent at all; the print functionality will merely split the page's contents up into areas of fixed size, without any regard for whether part of one content item becomes mangled and unreadable on the printed sheets due to that item being divided right down the middle among separate sheets. Web pages, as those pages are presented in a web browser window, often will not print nicely to a single paper. The results produced by printing a web page often leaves a user unsatisfied, with a result that might be difficult to read, and which often wastes print media.

Additionally, when a user instructs a web browser to print a web page using the browser's own (or the operating system's own) print functionality (e.g., by clicking on the browser's own “print” menu command), the browser and operating system typically will attempt to print all of the web page's content (but not any content to which the web page might link) without regard for whether certain portions of the content are likely to be of interest to the user when printed. For example, a user might be interested in one of stories 102-108 that are partially shown in the web page FIG. 1. Therefore, the user might instruct the web browser to print the web page. Unfortunately, the printed result will contain all of the other partial stories in which the user is not actually interested, as well as advertisement 110. This is wasteful of print media and toner.

Furthermore, if the one story in which the user is interested is split up into multiple portions, each of which is contained on a separate web page, then, in order to obtain a printed copy of the entire story, the user will have to navigate his browser manually to each such web page, and instruct his browser to print each such web page separately. Each such web page might also contain an abundance of additional information and images that do not relate to the story in which the user is interested, and each printed page will contain that information and those images also. Given the way that stories, articles, and other content items often are split up among multiple pages, printing an entire content item that spans several pages can be a time-consuming and irritating task for the user.

### SUMMARY

Techniques and systems for automatically printing partial web page content based on new Hypertext Markup Language (HTML) tags that are embedded within the web page itself are disclosed. In a web page that contains such content-delimiting HTML tags, the tags indicate which portions of the web page constitute separate content items. For example, in an enhanced version of the web page shown in FIG. 1, separate pairs of tags may enclose each of stories 102-108; each pair of tags encloses a different one of stories 102-108. A web browser that is instructed to print that version of the web page determines, based on the presence of the tags, that certain text and images on the web page belong together with a particular story. Using this information, the web browser can attempt to split the content items up in such a way that, for each content item, the text and images associated with that content item are not split up among printed sheets (or, if they must be split up, so that they are split up in a way that maintains the readability of the content item). Separate content items may be printed on separate sheets, and, in one implementation, each sheet contains no more than one story from the web page.

Additionally, in one embodiment of the invention, HTML tags embedded within a web page indicate which content items are stories, and therefore should be printed, and which content items are advertisements that should not be printed unless specifically requested by the user. For example, in an enhanced version of the web page shown in FIG. 1, special HTML tags may immediately precede and follow the image of advertisement 110. These special HTML tags indicate, to the web browser, that the data contained between the tags is an advertisement rather than a story. In response to a user's command to print the web page, the web browser reads these special tags and, due to the presence of those tags, refrains from printing advertisement 110.

Furthermore, in one embodiment of the invention, the web browser is enhanced such that when a user right-clicks on a particular area in the web page, the browser automatically determines, based on the content-delimiting tags embedded in the web page, a content item that at least partially occupied the point on which the user right-clicked. The web browser responsively presents, to the user, a menu that contains a user-selectable menu item for printing that content item alone, and in full. In response to the user's selection of that menu item, the web browser automatically reads special HTML tags that are embedded in the web page in order to determine whether the clicked-on content item spans multiple pages. For example, such an HTML tag may specify the URL of another web page on which the next portion of the clicked-on content item can be found. The web browser responsively loads and reads each of the special tag-indicated web pages in order to obtain all of the clicked-on content item's data, including text and images that may be a part of the content item. The web browser then automatically generates printable page data that contains all of the content item's data, even though that data was obtained from multiple separate pages. The web browser sends this printable page data to the printer rather than the contents of the original web page that the user was viewing. As a result, the clicked-on content item is printed, and other additional information (such as advertisements and/or other stories) that might have been present on the web pages that contained the content item's portions is not printed.

Beneficially, these and other techniques and system disclosed herein often save the user from having to navigate to multiple different web pages and print each web page. These techniques and systems also conserve print resources such as paper and toner by preventing the printing of information in which the user is not interested.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 shows an example of a portion of a web page as that web page might be partially displayed in an Internet browser's window;

FIG. 2 is a diagram that shows an example of the web page that a web browser would render and display in response to reading certain HTML code;

FIG. 3 is a flow diagram that shows an example technique that a web browser may use to print content items from web pages, according to an embodiment of the invention;

FIG. 4 is a block diagram that illustrates an example of a system in which techniques described herein may be performed, according to an embodiment of the invention;

FIG. 5 is a block diagram that illustrates an example of possible components within a web server and a client PC, according to an embodiment of the invention;

FIG. 6 is a diagram that illustrates an example of a possible communications interaction between a web server, a client PC, and a printing device, according to an embodiment of the invention; and

FIG. 7 is a block diagram that depicts a device upon which an embodiment of the invention may be at least partially implemented.

### DETAILED DESCRIPTION

In the following description, for the purposes of explanation, specific details are set forth in order to provide a thorough understanding of the invention. However, it will be apparent that the invention may be practiced without these specific details. In some instances, well-known structures and devices are depicted in block diagram form in order to avoid unnecessarily obscuring the invention.

### Overview

A web page is enhanced with special HTML print tags that were not previously contained in any web pages. These special HTML print tags indicate which of a web page's materials (e.g., text and images) belong to which content items. The web page may contain, or partially contain, several different content items, and the HTML print tags identify and distinguish between the content items. The web browser also uses the tags to differentiate “real” content (such as stories and articles) from advertisements and other unimportant content on the web page, so that unimportant content is not printed along with important content. Additionally, if the content is distributed over several pages, then the special HTML print tags convey information about which links the web browser should automatically follow in order to obtain and print the entire content. According to one embodiment of the invention, the special HTML print tags are embedded into a web document by either the author of the web document or by an automated process (if the document is dynamically generated). The foregoing approach can be contrasted with a system in which a user is required to request a separate “printer-friendly” web page for printing; in approaches discussed herein, the user does not need to cause his web browser to request any additional web page, because the browser automatically generates print data using the HTML print tags that are already contained in the original web page.

Beneficially, techniques disclosed herein enrich the web printing experience for users. These techniques allow users to print a document with one click without having to worry about the formatting or extraneous content being printed. Additionally, these techniques allow users to choose the formatting for their print job independent of any formatting imposed on the original document from the web server. Overall, techniques disclosed herein make printing a much more friendly service that becomes part of the web browsing work flow.

### Web Browser Display Formatting Using HTML Tags

HTML is the current standard for formatting content that is viewable in a web browser. Server devices produce the HTML content and send that content over the Internet to client devices (e.g., laptop computers, desktop computers, web-enabled mobile devices, etc.) in response to those devices' requests. HTML is one of several existing markup languages. A markup language generally is a set of annotations to text that describe how that text is to be structured, laid out, or formatted. Markup languages often exist in the form of markup codes used in computer typesetting and word-processing systems. These codes may be used to describe the required layout of papers, articles, standards, or books, or to instantiate a particular document. HTML is an instance of SGML and follows many of the markup conventions used in the publishing industry in the communication of printed work between authors, editors, and printers. Therefore, although embodiments of the invention described herein refer specifically to HTML, alternative embodiments of the invention may involve other markup languages instead of HTML. Such other markup languages may include Generalized Markup Language (GML), Standard Generalized Markup Language (SGML), Extensible Markup Language (XML), Extensible Hypertext Markup Language (XHTML), and/or any other markup language. The discussion below provides examples in HTML for purposes of disclosing a concrete and specific embodiment of the invention, but embodiments of the invention are not limited to HTML.

The Hypertext Transfer Protocol (HTTP) is one popular standard communication protocol that clients and servers use to transmit HTML information to each other over the Internet. The HTML specification describes the tags that are considered to be a part of standard HTML. These tags are specific text words that are enclosed within angular brackets (“<” and “>”). Examples of HTML formatting tags include “<TITLE>,” “<HEADER>,” “<BODY>,” “<LINK>,” etc. Such HTML formatting tags are embedded within the content of a document in order to separate the document into sections and in order to provide other information about how to display the content. Because such tags are typically only for the benefit of the browser in determining how to display the content, the browser typically does not display the tags themselves to a user when the browser displays the web page in which the tags are contained. Typically, in order to see the tags that are embedded within a web page, a user needs to instruct the browser to display that web page's source code. The source code of an example HTML document is shown below in Table 1:

TABLE 1
SOURCE CODE OF AN EXAMPLE HTML DOCUMENT

```
<!DOCTYPE HTML PUBLIC “-//W3C//DTD HTML 4.01//EN”
    “http://www.w3.org/TR/html14/strict.dtd”>
<HTML>
    <HEAD>
        <TITLE>My first HTML document</TITLE>
    </HEAD>
    <BODY>
        <P>Hello world!
    </BODY>
</HTML>
```

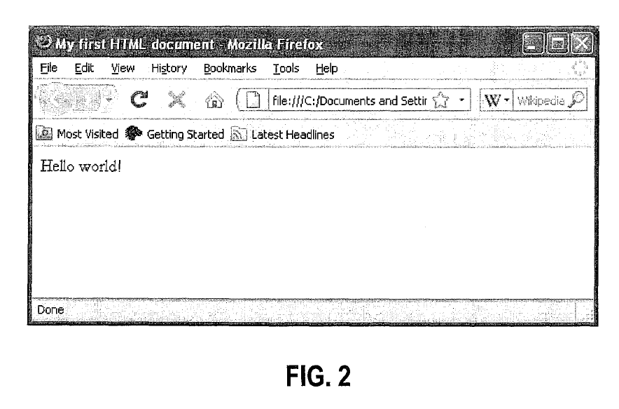

When a web browser executing on a client device receives the HTML document, via HTTP or some other protocol, the web browser parses the document and, using the embedded HTML tags, determines how best to display the document's content. FIG. 2 is a diagram that shows an example of the web page that a web browser would render and display in response to reading the HTML code shown in Table 1.

### META Tags Indicating Locations of a Content Item's Portions

Among other HTML tags that may be included in an HTML document is the META tag. This tag is used to convey metadata information that is associated with the document. The creator of the document can define new metadata types. For each such metadata type, the creator can associate a value with that type. By embedding META tags in an HTML document, the creator of the document can ensure that values that are specified in those tags are sent to each web browser that requests the document. Table 2 shows the source code of an example HTML document that contains a META tag having the name “Author” and having the value “David Brown” (thereby signifying that the document's author is David Brown).

TABLE 2
EXAMPLE HTML DOCUMENT SOURCE CODE CONTAINING
META TAG

```
<HTML>
    <HEAD>
        <META name=“Author” content=“David Brown”>
        <TITLE>My Web Page</TITLE>
    </HEAD>
    <BODY>
        Welcome to my page!
    </BODY>
</HTML>
```

META tags can be used to convey information that the web browser can use in determining how to print a content item that is at least partially contained in an HTML document. For example, in one embodiment of the invention, META tags in an HTML document indicate the URLs of each of the other web pages on which the several portions of a particular content item can be found, under circumstances in which the particular content item spans multiple web pages. For example, the following three META tags indicate that additional portions of a content item are found at the corresponding URLs specified in the values of those META tags:

<META name=“continuation1” content=“http://www.nonamenews.com/link1”>

<META name=“continuation2” content=“http://www.nonamenews.com/link2”>

<META name=“continuation3” content=“http://www.nonamenews.com/link3”>

In response to parsing the three meta tags above, the web browser would know that in response to a user's command to print the content item, the web browser should load each of the other documents found at the specified URLs and generate print data that contains portions of the content item found on each of the other documents (as well as the portion found on the original document in which the META tags were embedded). The web browser would then send, to the printer, the generated print data containing the entire content item rather than only the contents of the original document that the user was viewing in the browser at the time that the user instructed the browser to print the content item. In one embodiment of the invention, the web browser is specifically designed to recognize META tags that have specified names (such as “continuation1,” “continuation2,” “contination3,” and so forth), and, in response to parsing META tags that have those names, to retrieve information from the specified URLs and assemble print data as discussed above.

### HTML Print Tags

Although HTML tags have previously been used to instruct a web browser how to format an HTML document's content, such HTML tags have only previously been used to instruct a web browser how to format the document for presentation on screen—not for a printer. Sometimes, the manner in which a document should be formatted for printing on sheet media (e.g., paper) is quite different from the manner in which a document should be formatted for displaying on screen. Sometimes, while it may be desirable to display all of the portions of an HTML document on screen, it may also be desirable to omit some of those items when printing that HTML document.

According to one embodiment of the invention, an HTML document's content items that a web browser should send to a printer in response to a user's command to print the HTML document are enclosed within HTML print tags. HTML print tags may take the form, example of “<PRINT>” and “</PRINT>”—the “<PRINT>” tag indicates the beginning of a content item that should be printed, and the “</PRINT>” tag indicates the ending of that content item. In one embodiment of the invention, when a user instructs the web browser to print a document, the web browser parses the document and only sends, to the printer, data that is contained in between “<PRINT>” and “</PRINT>” tags. In such an embodiment of the invention, the web browser does not send, to the printer, any of the document's data that is not enclosed between such print tags. As a result, in such an embodiment of the invention, the printer only prints the parts of a document that are contained in between embedded print tags. Table 3, below, shows the source code of an example HTML document that contains print tags, according to an embodiment of the invention.

TABLE 3
EXAMPLE HTML DOCUMENT SOURCE CODE CONTAINING
PRINT TAGS

```
<HTML>
    <BODY>
        <P>
        <PRINT>
            A web page containing an image.
        </PRINT>
        <A HREF=“lastpage.htm”>
        <IMG BORDER=“0” SRC =“buttonnext.gif”
        WIDTH=“65” HEIGHT=“38”>
        </A>
        </P>
    </BODY>
</HTML>
```

According to one embodiment of the invention, in response to a web browser's receipt of a user's command to print a web page that has the source code above, the web browser would not send any of the above data to the printer except for the portion enclosed with the print tags-namely, “A web page containing an image.”

### Tags that Indicate Document Portions not to be Printed

In one embodiment of the invention, a document additionally or alternatively embeds tags that indicate portions of the document that, although displayed on screen, should not be sent to the printer in response to a user's command to print the document. For example, in one embodiment of the invention, all of the advertisements on a page are immediately preceded by an “<ADVERTISEMENT>” tag and immediately followed by an “</ADVERTISEMENT>” tag-thus indicating, to the web browser, that all of the data enclosed between those tags constitutes an advertisement. In one embodiment of the invention, in response to a user's instruction to print a document, the web browser intentionally omits, from the print data that the web browser sends to the printer, all data that is contained between the “advertisement” tags. As a result, the document, minus the advertisements contained therein, is printed. In an alternative embodiment of the invention, the web browser examines user-specified preferences in order to determine whether or not such advertisement content should be sent to the printer. Advertisement content may be sent to the printer along with the rest of a document's content if the user has indicated, in the settings, that the user also wants advertisements to be printed.

### Printing Options

In one embodiment of the invention, in response to receiving a user's command to print a document (e.g., a web page), a web browser parses the document and locates print tags that indicate which parts of the document should and should not be printed. Based on user-specified settings, the web browser generates print data and presents, to the user, a display of what the content will look like when printed (a “print preview”). In one embodiment of the invention, in response to a user's command to print a document, the web browser asks the user whether advertisements contained in the document should be printed, and, if so, whether they should be printed (a) in the same locations in which they appear in the displayed page, (b) in the margins of the printed page, or (c) on one or more pages that are separate from the pages on which the remainder of the page's contents are printed. The web browser then either prints or does not print the advertisements in accordance with the user's instructions.

Additionally or alternatively, in one embodiment of the invention, in response to a user's command to print a document, the web browser asks the user whether the URLs that are indicated in hyperlinks that are contained in the document should be printed in footnotes. If the user responds affirmatively, then, for each hyperlink that is contained in the document (or at least for each hyperlink that is contained in a portion of the document that will be printed, as discussed above), the web browser generates a numbered footnote that indicates the URL of the document to which that hyperlink refers, and inserts that footnote into the print data at the bottom of the sheet on which the hyperlink will be printed. For each such numbered footnote, the web browser places, in the print data, the footnote's number in superscript immediately to the right of the corresponding hyperlink's text, so that when the content is printed, the user will be able to tell which URL corresponds to which hyperlink text in the printed content.

Additionally or alternatively, in one embodiment of the invention, in response to a user's command to print a document, the web browser asks the user whether images that pertain to the content should be printed. If the user responds affirmatively, then, when the web browser generates the print data that is to be sent to the printer, the web browser includes, in the print data, all images that are within document portions that have been enclosed within HTML print tags (as described above). Even if the user responds affirmatively, the web browser does not include, in the print data, any images that are outside of these document portions (unless the user has specified that advertisements are to be printed). Alternatively, if the user responds negatively, then the web browser does not insert, into the print data, any images at all, even if those images occur inside of document portions that are enclosed by HTML print tags.

### Printing Specified Content Items that Span Multiple Pages

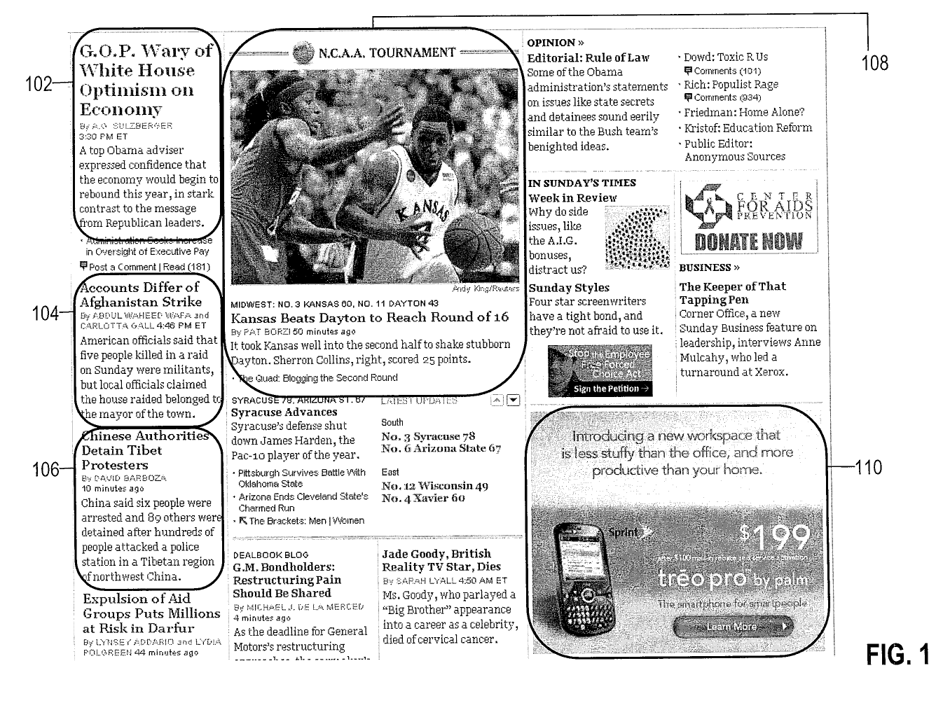

As is seen in FIG. 1, a web page may contain mere portions of multiple different stories 102-108. The web page might not contain a complete version of any of stories 102-108. Usually, to see the remainder of any of stories 102-108, a user might be required to click on a hyperlink that is displayed in conjunction with the particular story in which the user is interested. Clicking on such a hyperlink typically causes the web browser to load another web page that contains an additional portion of the story. That other web page itself might not contain all of the rest of the story; that other web page may link to yet another web page to which the user must navigate in order to continue reading the story in which the user is interested. Each such web page might contain advertisements and other information in which the user is not interested.

Traditionally, if the user wanted to print a particular story that spanned multiple pages, then the user would be required to instruct his web browser to navigate to each separate page that contained a portion of the story. For each and every such page, the user would be required to instruct his web browser to print the contents of that page in a separate action. This was an annoying and time-consuming process. Furthermore, the pages that were printed often would contain additional information (such as advertisements and other unrelated stories) in which the user was not interested.

According to one embodiment of the invention, in response to a user right-clicking (i.e., using a mouse or other pointing device) on an area of a web page, the web browser determines the identity of the content item that occupies the point on which the user right-clicked. The content item's identity may be indicated as an attribute within print tags that enclose that content item (or a portion thereof), for example. At that point, the web browser responsively presents, to the user, a pop-up menu that may include multiple options. Among these options is a user-selectable option for printing only the content item on which the user has right-clicked.

In response to the user's selection of this user-selectable option, the web browser loads (but does not necessarily display) each other page (if any) on which any portion of the same content item occurs. The web browser may determine the URLs of these other pages by reading META tags that are contained within (or which enclose) the content item, and loading the web pages that are located at the URLs specified within those META tags (as is discussed above). Sometimes, the web browser may encounter another META tag in a page that the web browser has automatically followed from a previous META tag. In response, the web browser follows that other META tag as well, loading yet another web page. In this manner, the web browser may automatically follow a chain of multiple META tag-specified URLs in order to retrieve all of the portions of a content item that spans several web pages.

It is possible that a web page that the browser subsequently loads in an effort to retrieve an additional portion of the selected content item will contain information that is not a part of that content item. In one embodiment of the invention, every portion of a particular content item is associated with an identifier that is unique to that content item. For example, for a particular content item, such as a story or article, each portion of that content item on each page on which any portion of that content item occurs may be enclosed within HTML tags (e.g., print tags and/or META tags) that specify, as an attribute of those HTML tags, the particular content item's unique identifier. Thus, when assembling the content item from data that occurs on multiple web pages, the web browser inserts, into the print data, only the portions of those pages that are associated with the unique identifier of the selected content item (i.e., the content item on whose portion the user originally right-clicked in the original page). After retrieving each portion of the selected content item, the web browser sends the print data, which only includes data that is associated with the selected content item (i.e., not other stories or advertisements that occurred on the same page with any portion of the selected content item), to the printer. The printer then prints the content item based on the assembled print data generated by the web browser.

Thus, for example, if a user right-clicks on story 108 and tells the web browser to print only that story, then, according to one embodiment of the invention, the web browser will insert, into the print data, the image and text that is contained within the tags that identify the beginning and end of story 108 on the initially viewed web page. The web browser will not, in such an embodiment of the invention, insert into the print data any of the web page's data that is not contained within those tags. Furthermore, the web browser will locate, with those tags, a URL of a web page that contains an additional portion of story 108. The web browser will load that page (typically without displaying that page to the user), find the additional portion of story 108 (e.g., by finding the portion that is associated with the unique identifier of story 108, as indicated on the initially viewed page), and insert that additional portion (but not any other portion of the page on which the additional portion occurs) into the print data. The web browser may subsequently load further portions of story 108 on subsequent pages using a similar technique, until, when all of the portions of story 108 have been inserted into the print data (as may be indicated by an “end of story” META tag found at the bottom of the last portion, for example), the web browser sends the assembled print data to the printer for printing.

### Formatting a Document Differently for Printing than for Display

In one embodiment of the invention, the new HTML tags discussed above allow print drivers to create new formatting designs that are especially suited for Internet content. For example, an article that is not formatted in columns on a displayed web page may be organized into columns for printing based on special “column” print tags that are embedded within the web page at locations in which content should be broken into separate columns for printing. For another example, the title, headers, and other content of a document, while potentially not hierarchically organized in the displayed web page, may be hierarchically organized in the print data for printing based on HTML tags that are contained in the document—this may be done in response to a user's specified request to print a web page in a hierarchical format, for example. For another example, in response to a user's request, the web browser may generate the print data in such a way that the images in the web page will be placed on one or more pages that are separate from the remainder of the content that is to be printed, so that even though the images appear with the text on the displayed web page, they are not similarly placed next to the text in the resulting printed document. Extending the example, in response to a user's request, the web browser may insert, into the print data, print directives that will cause the pages on which the images are separately printed to be printed on different media than the pages on which the remainder of the document is printed. More specifically, the web browser may ask the user on which types of media the “image pages” should be printed, and on which types of media the remaining content pages should be printed. The user may specify different types of media for each. For example, the user might select special glossy photo paper for the image pages, and regular inexpensive white paper for the remaining text of the document. The web browser responsively includes directives in the print data to cause the printer to make this happen.

### Example Technique

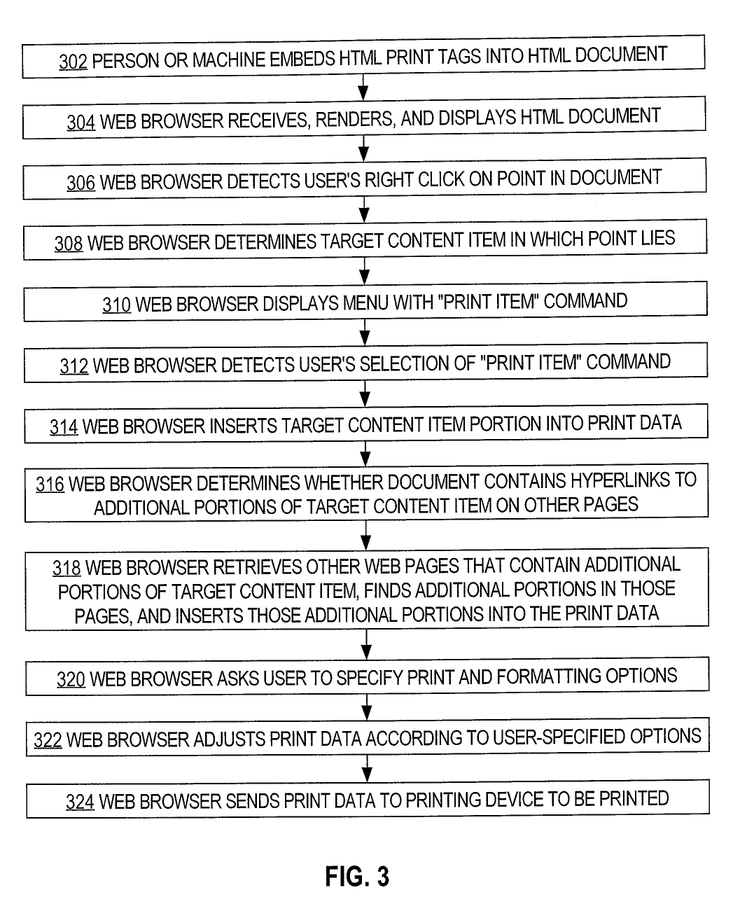

FIG. 3 is a flow diagram that shows an example technique that a web browser may use to print content items from web pages, according to an embodiment of the invention. Various alternative embodiments of the invention may include more, fewer, or different steps than those discussed below. Certain steps of the technique may be performed by a web browser program executing on a general purpose computer, or by a special-purpose non-general-purpose computer which was specifically assembled with hardware to perform these steps.

In block 302, a person or machine embeds HTML print tags into an HTML document. The HTML print tags distinguish content items in the document from each other.

In block 304, a web browser receives, renders, and displays the HTML document, not displaying the HTML print tags.

In block 306, the web browser detects that a user has right-clicked on a point in the HTML document that the web browser is currently displaying.

In block 308, in response to detecting that the user has right-clicked on the point, the web browser determines which of the HTML document's content items occupies the area in which the point lies. The content item in which the point lies is referred to hereafter as “the target content item.” In one embodiment of the invention, the web browser identifies the target content item by determining which HTML print tags in the HTML document's source code enclose the content upon which the user right-clicked. As is discussed above, such HTML print tags may specify a unique identifier for the target content item.

In block 310, in response to detecting that the user has right-clicked on the point, the web browser displays a pop-up menu that contains a “print this item” command.

In block 312, the web browser detects that the user has clicked on the “print this item” command in the pop-up menu.

In block 314, in response to detecting that the user has clicked on the “print this item” command in the pop-up menu, the web browser inserts, into print data, the data that is contained within the target content item's HTML print tags on the currently displayed web page.

In block 316, the web browser determines whether any hyperlinks, to any additional portions of the target content item on other web pages, are contained in the currently displayed web page.

In block 318, in response to determining that a hyperlink to an additional portion of the target content item is contained in the current web page, the web browser retrieves the other web page to which the hyperlink refers, finds the additional portion of the target content item on that other web page (e.g., by locating, on the other web page, the data that is enclosed within HTML print tags that specify the target content item's unique identifier), and inserts that additional portion of the target content item into the print data, thereby further assembling the target content item for printing.

The operations of block 318 may be performed in a recursive manner multiple times for each time that the next web page retrieved contains a further hyperlink to yet another web page that contains yet another portion of the content item. In one embodiment of the invention, the operations of block 318 are performed as many times as are required in order to retrieve all of the portions of the target content item and place those portions in the print data.

In block 320, after all of the portions of the target content item have been assembled and inserted into the print data, the web browser asks the user to specify the print and/or formatting options that the user wants to have used in printing the target content item. As is discussed above, some of these options may include printing or not printing advertisements and/or images, printing footnotes, printing advertisements and/or images in margins or on different sheets, and/or on different types of print media. These options may include printing the target content item according to a columnar or hierarchical format that differs from the format according to which the target content item was displayed on the screen, as is discussed above.

In block 322, after receiving the desired print and/or formatting options from the user, the web browser adjusts the print data so that the print data conforms to these desired options.

In block 324, the web browser sends the print data to a printing device. The printing device responsively prints the target content item on one or more sheets of media, in conformance with the preferences and settings specified by the user in block 322.

### Implementation Mechanisms

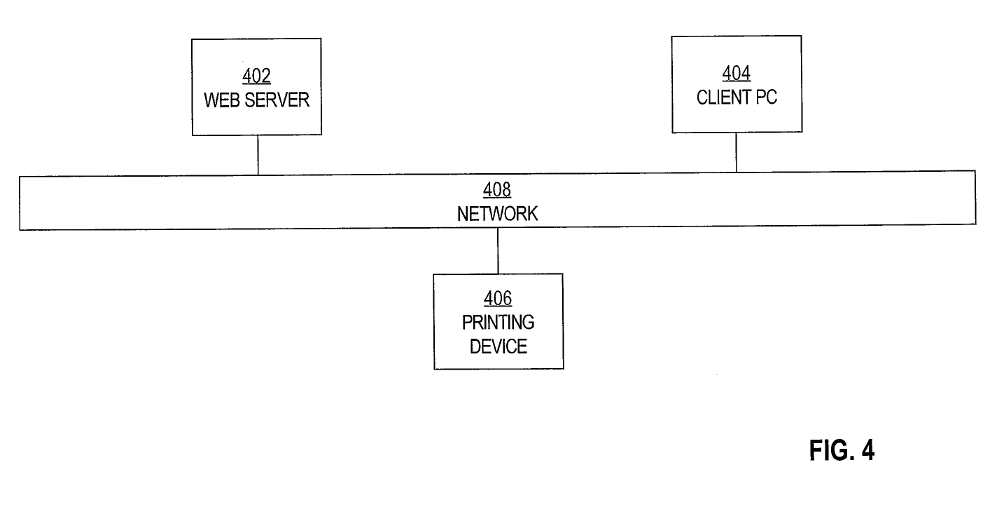

FIG. 4 is a block diagram that illustrates an example of a system in which the foregoing technique may be performed, according to an embodiment of the invention. The system illustrated in FIG. 4 includes a web server 402, a client personal computer (PC) 404, and a printing device 406. Each of web server 402, client PC 404, and printing device 406 are communicatively coupled (though potentially wirelessly) through a network 408 such as a local area network (LAN), wide area network (WAN), and/or the Internet. In this system, web server 402 serves web pages to web browser clients on remote devices (e.g., client PC 404) upon requests from those clients. The web pages can be generated automatically by processes executing on web server 402, or the web pages can be static web pages that are stored on web server 402. Regardless of whether the web pages are static or generated, HTML tags conveying information about the printable content of those web pages are embedded with those web pages by some mechanism. Such a mechanism can be, for example, a software module that traverses the HTML document and, based on the other HTML tags in the document, determines what the document's printable content is. The software module may then insert HTML print tags around that content. Another mechanism could involve the author of a static HTML document embedding HTML print tags into the document at the time of the document's creation. Another mechanism could involve a Java Servlet, which generates the document, also inserting the HTML print tags into the document.

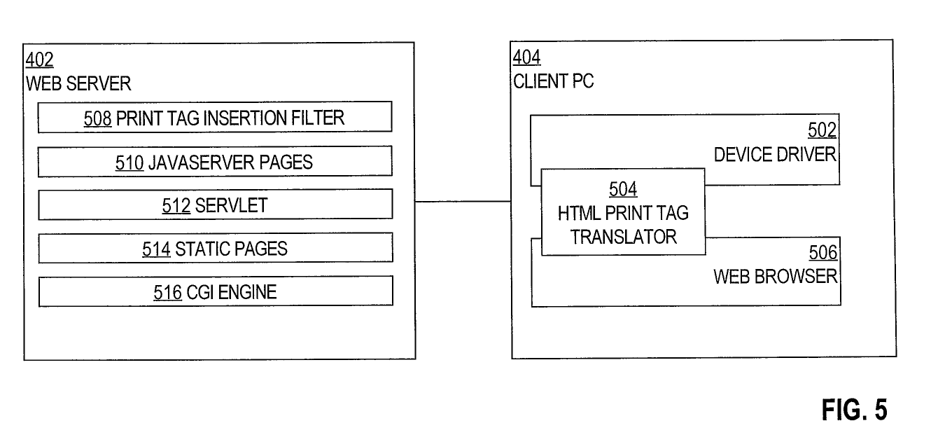

FIG. 5 is a block diagram that illustrates an example of possible components within web server 402 and client PC 404, according to an embodiment of the invention. Client PC 404 includes a device driver 502, an HTML print tag translator 504, and a web browser 506. Web server 402 includes a print tag insertion filter 508, JavaServer pages 510, a servlet 512, static pages 514, and a common gateway interface (CGI) engine 516. Web browser 506 may perform steps 302-324 of FIG. 3 as discussed above. Web server 402 may, in response to HTTP requests from web browser 506, invoke one or more of components 508-516 in order to generate and/or serve a web page to web browser 506 over the Internet. Web browser 506 would receive such a web page in step 304 of FIG. 3, discussed above. In response to a user's command to web browser 506 to print a portion or all of the web page, Web browser 506 may invoke HTML print tag translator 504 to perform, among other steps, steps 308 and 316 of FIG. 3, discussed above. For example, HTML print tag translator 504 may examine print tags in the page to determine in which section of the page the user clicked (step 308). For another example, HTML print tag translator 504 may examine print tags in the page to determine other pages on which additional sections of the selected content item are at least partially contained (step 316). Device driver 502 may be invoked to generate commands that are to be sent to a printing device. For example, device driver 502 may perform steps 320-324 of FIG. 3 in conjunction with web browser 506 in order to generate print data that the printing device can understand and use in order to print a physical document that resembles what the user wants to have produced. Device driver 506 may be considered a part of the operating system that executes on client PC 404, and may be invoked by numerous applications executing on client PC 404, including web browser 506.

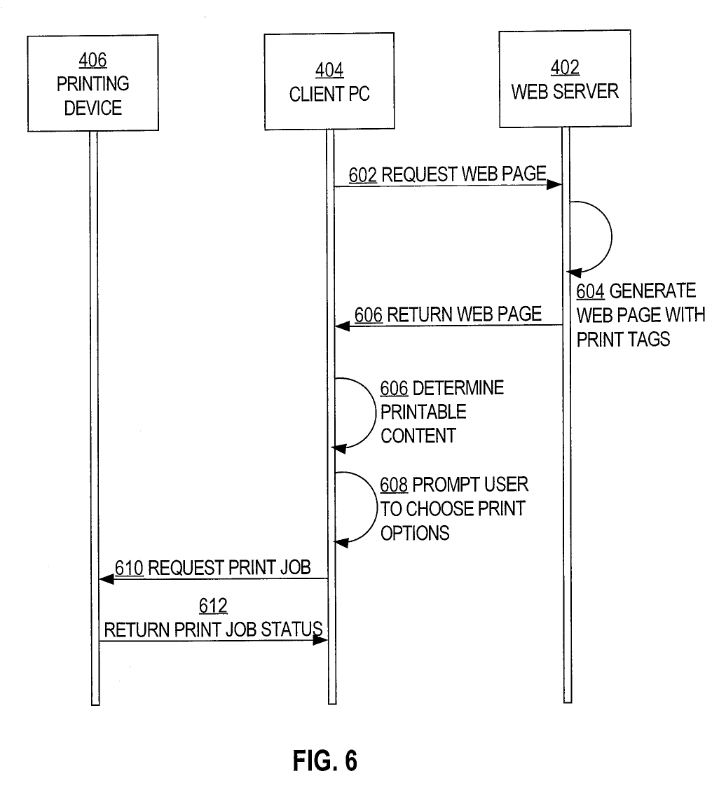

FIG. 6 is a diagram that illustrates an example of a possible communications interaction between web server 402, client PC 404, and printing device 406, according to an embodiment of the invention. In operation 602, client PC 404 requests a web page from web server 402. More specifically, web browser 506 of FIG. 5 may request this web page. In operation 604, web server 402 generates a web page that contains embedded HTML print tags. More specifically, web server 402 may invoke one or more of components 508-516 of FIG. 5 in order to generate and/or serve the web page. In operation 606, web server 402 returns the web page to client PC 404. In operation 608, client PC 404 determines the printable content within the web page based on the HTML print tags embedded in the web page. More specifically, web browser 506 may determine this context in conjunction with HTML print tag translator 504 of FIG. 5. In operation 610, client PC 404 prompts a user to choose print and formatting options. In one embodiment of the invention, web browser 506 invokes device driver 502 of FIG. 5 in order to prompt the user in this manner. In operation 612, client PC 404 requests that printing device 406 print a print job (using the printable content and according to the selected options). More specifically, device driver 502 of FIG. 5 may generate commands that are specific to a selected type of printing device, based on the user's specified preferences and the information generated by HTML print tag translator 504. In operation 614, printing device 406 prints the print job and returns the print job status to client PC 404. More specifically, the status may be returned via device driver 502 of FIG. 5, which may then pass a status message on to web browser 506, which may display a message to the user, indicating that the print job has been printed.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

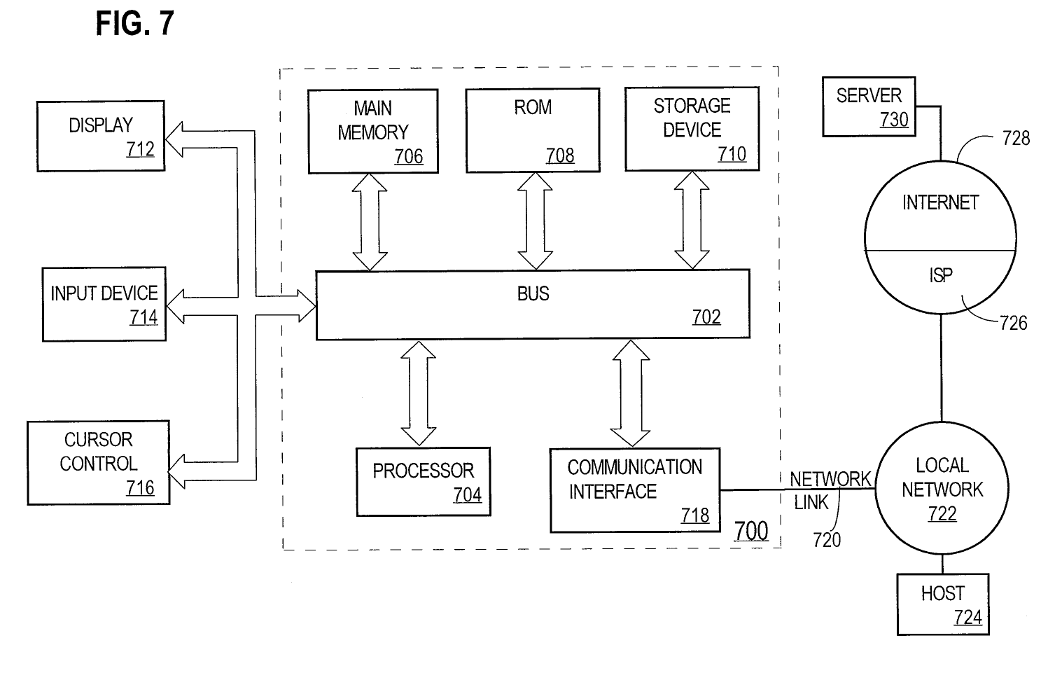

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

One embodiment of the invention comprises a non-general-computing, special-purpose machine which includes (a) an electronic tag reader which reads print tags that are embedded in a web page, (b) an electronic print data generator which generates print data that only includes data that is enclosed in between the print tags in the web page, and omits, from the print data, information that is not enclosed in between the print tags, (c) a printer interface that transmits the print data generated by the electronic print data generator to a printing device that is connected to the special-purpose non-general-computing machine, and (d) an electronic web page displayer that displays at least a portion of the web page, including at least some information that is enclosed between the print tags, and at least some information that is not enclosed between the print tags. Each of these machine components is, in one embodiment of the invention, communicatively coupled with each other of these machine components.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
reading a tag that is embedded in a document and that identifies a specific portion of the document that is less than all of the document;
determining, based on a presence of the tag in the document, that the specific portion of the document, and no other portion of the document other than zero or more user-specified portions of the document, should be printed;
in response to determining that the specific portion of the document should be printed, and in response to a user's instruction to print at least part of the document, inserting, into print data, (a) the specific portion of the document and (b) any other portions of the document that the user has expressly instructed to be printed, while excluding, from the print data, all remaining portions of the document; and
causing the specific portion of the document to be printed by a printing device by sending the print data to the printing device.

2. The method of claim 1, wherein the tag is a hypertext markup language (HTML) tag, wherein the document is a web page, and wherein the steps of reading, determining, and inserting are performed by a web browser that is currently displaying at least a section of the web page.

3. The method of claim 1, wherein the other portions of the document that the user has expressly instructed to be printed include one or more advertisements, and further comprising:
identifying the one or more advertisements in the document based on advertisement-specifying HTML tags that are embedded in the document;
asking a user whether the one or more advertisements should be printed;
in response to the user's instructions to print the one or more advertisements, asking the user whether the one or more advertisements should be printed on one or more additional pages that are separate from one or more pages on which the specific portion will be printed; and
in response to the user's instructions to print the one or more advertisements on the one or more additional pages, inserting, into the print data, commands that will cause the one or more advertisements to be printed on one or more sheets that are separate from one or more sheets on which the specific portion will be printed.

4. The method of claim 1, further comprising:
determining that a user has mouse-clicked on a particular point within the document;
determining that the particular point is contained within an area that is occupied by the specific portion;
in response to determining that the particular point is contained within the area, presenting the user with a particular printing option for printing a content item that the specific portion at least partially represents;
in response to the user's selection of the particular printing option, automatically following one or more links to one or more additional web pages that each contain a separate portion of the content item; and
for each particular web page of the one or more additional web pages, inserting, into the print data, a portion of the content item that is found on that web page, but no other data that is found on that web page.

5. The method of claim 1, further comprising:
reading a metadata tag that indicates that an additional portion of a content item, which is only partially represented by the specific portion, is located on a web page that is separate and distinct from the document in which the specific portion occurs; and
in response to reading the metadata tag, automatically retrieving the web page and inserting the additional portion of the content item into the print data;
wherein the metadata tag indicates a uniform resource locator of the web page that contains the additional portion.

6. The method of claim 1, further comprising:
for each hyperlink that is contained in the specific portion, inserting, into the print data, a footnote that expressly specifies a uniform resource locator of a resource to which that hyperlink refers; and
adjusting the print data to contain, in superscript immediately next to a particular hyperlink whose uniform resource locator is expressly specified in a particular footnote, an identifier that correlates the particular hyperlink with the particular footnote.

7. The method of claim 1, further comprising:
organizing particular content that is specified within the print data into two or more columns based on a presence of a column-breaking HTML tag in the document;
wherein the particular content is not displayed in more than one column by a web browser that displays the particular content.

8. The method of claim 1, further comprising:
organizing particular content that is specified within the print data according to a hierarchical structure based on a presence of one or more HTML tags in the document;
wherein the particular content is not displayed according to the hierarchical structure by a web browser that displays the particular content.

9. The method of claim 1, further comprising:
in response to a user's request to print images from the document on one or more particular sheets that are separate from sheets on which text from the document are to be printed, inserting, into the print data, commands that cause the printing device to print the text on one or more first sheets, and commands that cause the printing device to print the images on one or more second sheets that are separate from the one or more first sheets;
wherein the one or more second sheets are of a different type of media than the one or more first sheets are; and
wherein the images and the text occur on a same web page that the document represents.

10. A volatile or non-volatile computer-readable storage medium storing one or more sequences of instructions, wherein execution of the one or more sequences of instructions by one or more processors causes the one or more processors to perform the steps of:
reading a tag that is embedded in a document and that identifies a specific portion of the document that is less than all of the document;
determining, based on a presence of the tag in the document, that the specific portion of the document, and no other portion of the document other than zero or more user-specified portions of the document, should be printed;
in response to determining that the specific portion of the document should be printed, and in response to a user's instruction to print at least part of the document, inserting, into print data, (a) the specific portion of the document and (b) any other portions of the document that the user has expressly instructed to be printed, while excluding, from the print data, all remaining portions of the document; and
causing the specific portion of the document to be printed by a printing device by sending the print data to the printing device.

11. The volatile or non-volatile computer-readable storage medium of claim 10, wherein the tag is a hypertext markup language (HTML) tag, wherein the document is a web page, and wherein the steps of reading, determining, and inserting are performed by a web browser that is currently displaying at least a section of the web page.

12. The volatile or non-volatile computer-readable storage medium of claim 10, wherein the other portions of the document that the user has expressly instructed to be printed include one or more advertisements, and wherein the steps further comprise:
identifying the one or more advertisements in the document based on advertisement-specifying HTML tags that are embedded in the document;
asking a user whether the one or more advertisements should be printed;
in response to the user's instructions to print the one or more advertisements, asking the user whether the one or more advertisements should be printed on one or more additional pages that are separate from one or more pages on which the specific portion will be printed; and
in response to the user's instructions to print the one or more advertisements on the one or more additional pages, inserting, into the print data, commands that will cause the one or more advertisements to be printed on one or more sheets that are separate from one or more sheets on which the specific portion will be printed.

13. The volatile or non-volatile computer-readable storage medium of claim 10, wherein the steps further comprise:
determining that a user has mouse-clicked on a particular point within the document;
determining that the particular point is contained within an area that is occupied by the specific portion;
in response to determining that the particular point is contained within the area, presenting the user with a particular printing option for printing a content item that the specific portion at least partially represents;
in response to the user's selection of the particular printing option, automatically following one or more links to one or more additional web pages that each contain a separate portion of the content item; and
for each particular web page of the one or more additional web pages, inserting, into the print data, a portion of the content item that is found on that web page, but no other data that is found on that web page.

14. The volatile or non-volatile computer-readable storage medium of claim 10, wherein the steps further comprise:
reading a metadata tag that indicates that an additional portion of a content item, which is only partially represented by the specific portion, is located on a web page that is separate and distinct from the document in which the specific portion occurs; and
in response to reading the metadata tag, automatically retrieving the web page and inserting the additional portion of the content item into the print data;
wherein the metadata tag indicates a uniform resource locator of the web page that contains the additional portion.

15. The volatile or non-volatile computer-readable storage medium of claim 10, wherein the steps further comprise:
for each hyperlink that is contained in the specific portion, inserting, into the print data, a footnote that expressly specifies a uniform resource locator of a resource to which that hyperlink refers; and
adjusting the print data to contain, in superscript immediately next to a particular hyperlink whose uniform resource locator is expressly specified in a particular footnote, an identifier that correlates the particular hyperlink with the particular footnote.

16. The volatile or non-volatile computer-readable storage medium of claim 10, wherein the steps further comprise:
organizing particular content that is specified within the print data into two or more columns based on a presence of a column-breaking HTML tag in the document;
wherein the particular content is not displayed in more than one column by a web browser that displays the particular content.

17. The volatile or non-volatile computer-readable storage medium of claim 10, wherein the steps further comprise:
organizing particular content that is specified within the print data according to a hierarchical structure based on a presence of one or more HTML tags in the document;
wherein the particular content is not displayed according to the hierarchical structure by a web browser that displays the particular content.

18. The volatile or non-volatile computer-readable storage medium of claim 10, wherein the steps further comprise:
in response to a user's request to print images from the document on one or more particular sheets that are separate from sheets on which text from the document are to be printed, inserting, into the print data, commands that cause the printing device to print the text on one or more first sheets, and commands that cause the printing device to print the images on one or more second sheets that are separate from the one or more first sheets;
wherein the one or more second sheets are of a different type of media than the one or more first sheets are; and
wherein the images and the text occur on a same web page that the document represents.

19. A special-purpose non-general-computing machine comprising:
an electronic tag reader which reads print tags that are embedded in a web page;
an electronic print data generator which generates print data that only includes data that is enclosed in between the print tags in the web page, and omits, from the print data, information that is not enclosed in between the print tags; and
a printer interface that transmits the print data generated by the electronic print data generator to a printing device that is connected to the special-purpose non-general-computing machine.

20. The special-purpose non-general-computing machine of claim 19, further comprising:
an electronic web page displayer that displays at least a portion of the web page, including at least some information that is enclosed between the print tags, and at least some information that is not enclosed between the print tags.
